(19) United States
(12) Patent Application Publication
(10) Pub. No.: US 2013/0330636 A1
(43) Pub. Date: Dec. 12, 2013

(54) NONAQUEOUS ELECTROLYTE AND NONAQUEOUS ELECTROLYTE SECONDARY BATTERY USING SAME

(71) Applicant: Masaki Deguchi, Hyogo (JP)

(72) Inventor: Masaki Deguchi, Hyogo (JP)

(73) Assignee: PANASONIC CORPORATION, Osaka (JP)

(21) Appl. No.: 13/978,712

(22) PCT Filed: Mar. 26, 2012
(86) PCT No.: PCT/JP2012/002082

§ 371 Date: Jul. 23, 2013

(30) Foreign Application Priority Data
Mar. 28, 2011 (JP) 2011-070415

(51) Int. Cl. H01M 10/0564

(52) U.S. Cl. CPC H01M 10/0564
USPC 429/338

(57) ABSTRACT

The present invention provides a non-aqueous electrolyte for secondary batteries, capable of suppressing gas generation in the secondary batteries during storage in a high-temperature environment or during charge/discharge cycles; and also provides a non-aqueous electrolyte secondary battery using the same. The non-aqueous electrolyte includes a non-aqueous solvent, a solute dissolved in the non-aqueous solvent, and an additive. The non-aqueous solvent includes ethylene carbonate and propylene carbonate. In the non-aqueous solvent, a content W_{EC} of the ethylene carbonate is 5 to 20 mass % and a content W_{PC} of the propylene carbonate is 40 to 60 mass %. The additive includes a sultone compound which includes a fluorine atom.

### TECHNICAL FIELD

The present invention relates to a non-aqueous electrolyte and a non-aqueous electrolyte secondary battery, and in particular, to an improvement of a non-aqueous electrolyte containing ethylene carbonate (EC) and propylene carbonate (PC).

### BACKGROUND ART

In non-aqueous electrolyte secondary batteries represented by lithium ion secondary batteries, a non-aqueous solvent solution of a lithium salt such as LiPF₆ and LiBF₄ is used as a non-aqueous electrolyte. Examples of a non-aqueous solvent include cyclic carbonates such as EC and PC; and chain carbonates such as ethylmethyl carbonate (EMC), dimethyl carbonate (DMC), and diethyl carbonate (DEC). Typically, there are many instances where two or more carbonates are used in a combination. Moreover, it is known to add an additive to a non-aqueous electrolyte, so as to improve battery characteristics.

Until now, expectations have been high for PC among carbonates. However, PC has poor compatibility with a carbon material, and it is therefore difficult to use PC in a combination with a negative electrode which uses graphite. Thus, studies are being made on the use of EC, in place of PC, as a main component in a non-aqueous solvent.

Patent Literatures 1 and 2 both disclose a non-aqueous electrolyte comprising a non-aqueous solvent which contains EC as a main component, to which a sultone compound is added as an additive.

Specifically, Patent Literature 1 proposes a non-aqueous electrolyte comprising a non-aqueous solvent which contains EC or the like, to which a sultone compound such as 1,3-propane sultone is added for the purpose of improving charge/discharge cycle characteristics of a non-aqueous electrolyte secondary battery. Examples in Patent Literature 1 use, for example, a non-aqueous electrolyte containing 1,3-propane sultone, EC, and DEC in proportions by volume of 10:45:45.

Moreover, Patent Literature 2 proposes a non-aqueous electrolyte comprising a non-aqueous solvent which contains EC or the like, to which an unsaturated sultone compound such as 1,3-propene sultone is added for the purpose of improving high-temperature storage characteristics of a non-aqueous electrolyte secondary battery. Examples in Patent Literature 2 use a non-aqueous electrolyte comprising a non-aqueous solvent which contains EC and EMC in proportions by weight of 4:6, to which 0.5 to 3 wt % of 1,3-propene sultone is added.

### PRIOR ART

### Patent Literature

[Patent Literature 1] Japanese Laid-Open Patent Publication No. Hei 11-162511
[Patent Literature 2] Japanese Laid-Open Patent Publication No. 2002-329528

### SUMMARY OF INVENTION

### Problem of Invention

EC has a high dielectric constant and therefore has excellent lithium ion conductivity. However, it has a relatively high melting point and tends to have a high viscosity at low temperatures. In contrast, chain carbonates such as DEC and EMC do not have such a high dielectric constant, but have a low viscosity. Viscosity of a non-aqueous electrolyte increases remarkably, particularly at low temperatures; and at low temperatures, ion conductivity becomes low and discharge characteristics tend to deteriorate. Therefore, as in the Examples of Patent Literatures 1 and 2, EC is usually used in a combination with a chain carbonate such as DEC and EMC.

However, with respect to a non-aqueous electrolyte containing EC as a main component, oxidative decomposition of EC occurs at the positive electrode in the battery during storage in a high-temperature environment and during charge/discharge cycles; and a large amount of gas such as CO gas and CO₂ gas are generated. In terms of lithium ion conductivity, in a conventional non-aqueous electrolyte, the EC content in the non-aqueous solvent is large, and therefore, gas generation which accompanies oxidative decomposition of EC at the positive electrode tends to occur to a significant extent. Moreover, even in instances where a lithium-containing transition metal oxide further containing Ni is used as the positive electrode active material, gas generation caused by EC decomposition tends to occur to a significant extent.

With respect to the non-aqueous solvents disclosed in Patent Literatures 1 and 2, although the proportion of EC is large, deterioration of rate characteristics which accompanies the viscosity of EC can be suppressed to a certain extent, since a chain carbonate such as DEC and EMC is added in large amounts. However, in instances where the proportion of the chain carbonate is large, a large amount of gas is produced and charge/discharge capacities become lower in the battery, particularly during storage in a high-temperature environment and during repeated charge/discharge. This is because a chain carbonate tends to produce gas through oxidative decomposition and reductive decomposition.

In contrast, although PC has a high electric conductivity and is suited for use as a non-aqueous solvent in a non-aqueous electrolyte, PC has a high viscosity. Moreover, compared to a chain carbonate, PC has higher resistance to oxidative decomposition at the positive electrode but is more prone to reductive decomposition at the negative electrode. Therefore, even if 1,3-propane sultone and 1,3-propene sultone are used as in Patent Literatures 1 and 2, it would not be possible to sufficiently suppress reductive decomposition of PC.

### Solution to Problem

The present invention aims to provide a non-aqueous electrolyte capable of suppressing gas generation in a non-aqueous electrolyte secondary battery during storage in a high-temperature environment or during charge/discharge cycles. It also aims to provide a non-aqueous electrolyte secondary battery which uses such a non-aqueous electrolyte.

One aspect of the present invention is directed to a non-aqueous electrolyte for secondary batteries, the non-aqueous electrolyte comprising a non-aqueous solvent, a solute dissolved in the non-aqueous solvent, and an additive, the non-aqueous solvent including EC and PC, the content W_{EC} of the EC in the non-aqueous solvent being 5 to 20 mass %, the content W_{PC} of the PC in the non-aqueous solvent being 40 to 60 mass %, and the additive comprising a sultone compound which includes a fluorine atom.

Another aspect of the present invention is directed to a non-aqueous electrolyte secondary battery comprising:

a positive electrode including a positive electrode current collector, and a positive electrode mixture layer formed on a surface of the positive electrode current collector and including a positive electrode active material;

a negative electrode including a negative electrode current collector, and a negative electrode active material layer formed on a surface of the negative electrode current collector and including a negative electrode active material;

a separator interposed between the positive electrode and the negative electrode; and

the above-described non-aqueous electrolyte.

### Advantageous Effect of Invention

According to the present invention, it is possible to suppress gas generation in a non-aqueous electrolyte secondary battery, even during storage in a high-temperature environment and/or during repeated charge/discharge.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWING

FIG. 1 is a vertical sectional view which schematically illustrates the constitution of a non-aqueous electrolyte secondary battery in accordance with one embodiment of the present invention.

### DESCRIPTION OF EMBODIMENTS

(Non-Aqueous Electrolyte)

A non-aqueous electrolyte of the present invention comprises a non-aqueous solvent, a solute dissolved in the non-aqueous solvent, and an additive. The non-aqueous solvent contains EC and PC. The additive contains a sultone compound which contains a fluorine atom (hereinafter referred to as sultone compound A).

A conventional non-aqueous electrolyte contains as a main solvent, EC having a high dielectric constant. Therefore, since it has a large EC content while also having excellent lithium ion conductivity, oxidative decomposition of EC at the positive electrode occurs to a significant extent; and the amount of gas generated becomes large in the battery, particularly during storage in a high-temperature environment and during charge/discharge cycles.

Therefore, in the present invention, PC, which has a high dielectric constant and is more resistant to oxidative decomposition compared to EC, is added to the non-aqueous solvent; and the content of EC in the non-aqueous solvent is made relatively small, so as to suppress the above-described oxidative decomposition of EC, while also maintaining the high dielectric constant of the non-aqueous electrolyte.

Specifically, in the present invention, the content W_{PC} of PC in the non-aqueous solvent is 40 to 60 mass % and thus relatively large, and the content W_{EC} of EC in the non-aqueous solvent is 5 to 20 mass % and thus relatively small.

However, when the PC content in the non-aqueous solvent is made large, reductive decomposition of PC occurs at the negative electrode and the amount of gas generated becomes large in the battery, particularly during storage in a high-temperature environment and during charge/discharge cycles. Moreover, in instances where the negative electrode includes a carbon material, PC reacts intensely with the carbon material and causes the negative electrode to deteriorate.

Therefore, the sultone compound A is included as the additive in the non-aqueous electrolyte of the present invention. This enables effective suppression of reductive decomposition of PC.

In terms of lithium ion absorbing/releasing properties of the negative electrode, the content W_{EC} of EC in the non-aqueous solvent is 5 mass % or more, preferably 7 mass % or more, and further preferably 10 mass % or more. To suppress gas generation caused by oxidative decomposition of EC while also maintaining charge acceptance at the negative electrode, the content W_{EC} of EC is 20 mass % or less, preferably 18 mass % or less, and further preferably 15 mass % or less. The upper limit and the lower limit may be in arbitrary combinations.

In terms of suppression of gas generation caused by oxidative decomposition of EC, and also of charge/discharge characteristics of the negative electrode, the content W_{EC} is 5 to 20 mass %, preferably 7 to 18 mass %, and further preferably 10 to 15 mass %.

To suppress gas generation caused by oxidative decomposition of EC, the content W_{PC} of PC in the non-aqueous solvent is 40 mass % or more, preferably 42 mass % or more, and further preferably 45 mass % or more. To suppress gas generation caused by reductive decomposition of PC, the content W_{PC} is 60 mass % or less, preferably 58 mass % or less, and further preferably 55 mass % or less. The upper limit and the lower limit may be in arbitrary combinations. In terms of suppressing gas generation caused by oxidative decomposition of EC, and also, of suppressing gas generation caused by reductive decomposition of PC, the content W_{PC} is, for example, 40 to 60 mass %, preferably 42 to 58 mass %, and further preferably 45 to 55 mass %.

In terms of obtaining, in a balanced manner, the effect of suppressing oxidative decomposition of EC and the effect of suppressing reductive decomposition of PC, the ratio W_{PC}/W_{EC} of the PC content W_{PC} relative to the EC content W_{EC}, is, for example, 2.25 to 6, preferably 3 to 6, and further preferably 3 to 5. When the ratio W_{PC}/W_{EC} is 2.25 or more, gas generation caused by oxidative decomposition of EC is suppressed more effectively, at the positive electrode, particularly. When the ratio W_{PC}/W_{EC} is 6 or more, gas generation caused by reductive decomposition of PC is suppressed more effectively, at the negative electrode, particularly.

The molecule of the sultone compound A has a ring (sultone ring) structure which includes a —SO₂—O— group, and also has a fluorine atom directly or indirectly bonded to the sultone ring. The sultone compound A may have a substituent such as a hydrocarbon group on a carbon atom of the sultone ring. A fluorine atom in the sultone compound A may be bonded to a carbon atom of the sultone ring, or may be in a substituent such as a hydrocarbon group or the like. In instances where a fluorine atom is included in a hydrocarbon group, it is acceptable as long as at least one hydrogen atom therein is replaced with a fluorine atom.

During charge/discharge of the battery, a stable film (SIE: Solid Electrolyte Interface) derived from the sultone compound A is formed on the surface of the negative electrode. This enables suppression of reductive decomposition of PC at the negative electrode, and also, of deterioration of the negative electrode. Although the decomposition potential of PC is about 0.9 V versus lithium, the sultone compound A forms the film at a high potential of 1.1 to 1.3 V. Therefore, formation of the film derived from the sultone compound A occurs preferentially over reductive decomposition of PC.

Moreover, with respect to a conventional non-aqueous electrolyte, there are instances where lithium metal is deposited on the negative electrode surface, when a battery is overcharged in a low-temperature environment. The deposited lithium metal is extremely unstable, and is liable to jeopardize battery safety by becoming the cause of ignition and heating. In particular, when a battery is stored in a high-temperature environment with lithium metal left deposited on the negative electrode surface, there are instances where abnormal heating of the battery occurs due to the deposited lithium metal.

It is presumed that the sultone compound A in the non-aqueous electrolyte of the present invention reacts with the deposited lithium, and forms a stable compound which includes fluorine and lithium. Therefore, even when lithium is deposited on the negative electrode surface due to battery overcharging or the like in a low-temperature environment, the deposited lithium is made stable by the sultone compound A. This prevents the battery from abnormal heating, even when it is stored in a high-temperature environment. That is, use of the sultone compound A makes abnormal heating of the battery highly unlikely even when lithium is deposited, and thus improves battery safety.

In recent years, safety standards for non-aqueous electrolyte secondary batteries have become very high. For example, there is a test in which a battery overcharged at a low temperature of about −5° C. is deliberately heated up to about 130° C. Even in such a test, a high level of safety can be achieved by using the non-aqueous electrolyte of the present invention.

With respect to the sultone compound A, one may be used singly, or two or more may be used in a combination.

Examples of the sultone compound A include compounds represented by the following formula W.

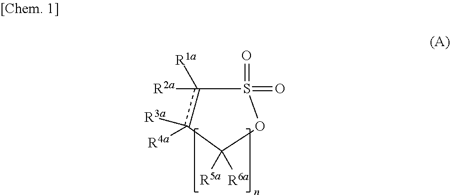

In the formula (A), R^{1a} to R^{6a} are independently a fluorine atom, a hydrogen atom, or a hydrocarbon group that may have a fluorine atom, and R^{2a} and R^{3a} may be taken together to form a double bond. n denotes the number of repetitions for a methylene group having R^{5a} and R^{6a}, and is an integer of 1 to 3. When n is 2 or 3, R^{5a} and R^{6a} in the methylene groups may be the same respectively or may be different from each other. At least one of R^{1a} to R^{6a} is a fluorine atom, or a hydrocarbon group having at least one fluorine atom.

Examples of the hydrocarbon group represented by R^{1a} to R^{6a} include saturated or unsaturated aliphatic hydrocarbon groups such as alkyl groups and alkenyl groups. Examples of the alkyl groups include linear or branched alkyl groups such as methyl group, ethyl group, n-propyl group, isopropyl group, n-butyl group, sec-butyl group, tert-butyl group, and pentyl groups. Examples of the alkenyl groups include linear or branched alkenyl groups such as vinyl group, 1-propenyl group, 2-propenyl group, 1-butenyl group, and 2-butenyl group.

In the above-described hydrocarbon group and hydrocarbon group having a fluorine atom, the number of carbon atoms is, for example, 1 to 6, preferably 1 to 5, and further preferably 1 to 4.

In instances where the hydrocarbon group has a fluorine atom, the number of fluorine atoms can be selected as appropriate in accordance with the number of carbon atoms, but is, for example, 1 to 5, preferably 1 to 3, and further preferably 1 or 2.

To reduce the viscosity of the non-aqueous electrolyte, the hydrocarbon group is preferably an alkyl group having 1 to 5 carbon atoms, and further preferably an alkyl group having 1 to 3 carbon atoms.

Among the sultone compounds represented by the formula (A), the saturated sultone compounds having R^{2a} and R^{3a} can be represented by the following formula (A-1).

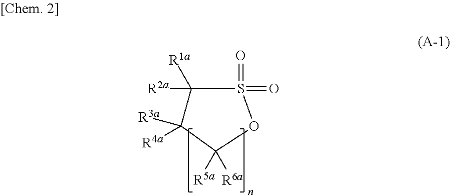

In the formula (A-1), R^{1a} to R^{6a} and n are the same as those in the foregoing formula.

Moreover, among the sultone compounds represented by the formula (A), the unsaturated sultone compounds, in which R^{2a} and R^{3a} are taken together to form a double bond, can be represented by the following formula (A-2).

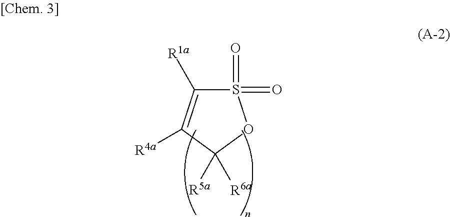

In the formula (A-2), R^{1a} to R^{6a} and n are the same as those in the foregoing formulae.

The saturated sultone compounds and the unsaturated sultone compounds represented by the foregoing formulae are capable of remarkably suppressing gas generation in the battery during storage in a high-temperature environment and during charge/discharge cycles. They also have excellent compatibility with, and stability in, the non-aqueous electrolyte.

Compared to the unsaturated sultone compound, the saturated sultone compound represented by the formula (A-1) is more advantageous in terms of being relatively easy to handle, not being liable to deactivate by causing a radical polymerization reaction with oxygen in air during storage of the battery.

In the unsaturated sultone compound represented by the formula (A-2), electron delocalization occurs during the process of film formation, due to the presence of the carbon-carbon double bond adjacent to the S atom in —SO₂—O—. Moreover, radical electrons are prone to reside stably on the carbon atom adjacent to the sulfur atom, and the degree of polymerization of the polymer structure in the film can be increased. Still moreover, since the unsaturated sultone compound has a higher reductive potential compared to the saturated sultone compound, its film is prone to be preferentially formed on the negative electrode surface. Therefore, when the unsaturated sultone compound is used, reductive decomposition of PC at the negative electrode surface can be suppressed more effectively. Note that the unsaturated sultone compound forms a film at a high potential of about 1.3 V (e.g., about 1.2 to 1.3 V) versus lithium.

In the formulae (A), (A-1), and (A-2), the moiety of the methylene group having R^{5a} and R^{6a}, with n number of repetitions, can be represented in accordance with the number given for n. Specifically, it can be represented by the following formulae (a-1) to (a-3).

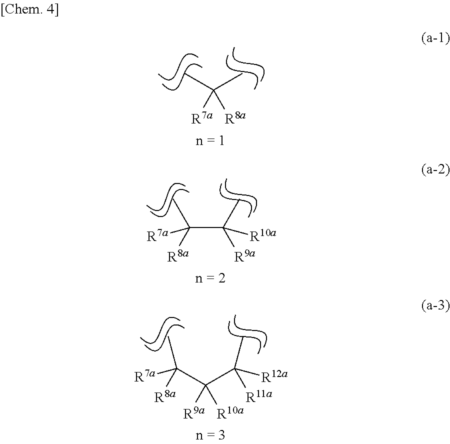

In the formulae (a-1) to (a-3), R^{7a} to R^{12a} correspond to the foregoing R^{5a} and R^{6a}, and are independently a fluorine atom, a hydrogen atom, or a hydrocarbon group that may have a fluorine atom.

Note that with respect to the formulae (A) and (A-1), the meaning of “at least one of R^{1a} to R^{6a}” is “at least one of R^{1a} to R^{4a}, R^{7a}, and R^{8a}”, when the moiety of the methylene group having R^{5a} and R^{6a} with n number of repetitions, is represented by the formula (a-1); is “at least one of R^{1a} to R^{4a} and R^{7a} to R^{10a}”, when represented by the formula (a-2); and is “at least one of R^{1a} to R^{4a} and R^{7a} to R^{12a}”, when represented by the formula (a-3). Note that with respect to the formula (A-2), when the formulae (a-1), (a-2), and (a-3) are used in the same manner as above, the meaning of “at least one of R^{1a} to R^{6a}” changes in the same manner as above, respectively, expect that R^{2a} and R^{3a} are excluded from each range of choice.

With respect to the sultone compounds of the formulae (A), (A-1), and (A-2), the total number of fluorine atoms and hydrocarbon groups having a fluorine atom that the sultone ring has as R^{1a} to R^{6a}, can be selected as appropriate in accordance with the number of members (i.e., n number of repetitions) of the sultone ring and the presence/absence of the double bond in the sultone ring; and is, for example, 1 to 6, preferably 1 to 5, further preferably 1 to 3, and particularly preferably 1 or 2.

With respect to the sultone compounds of the formulae (A) and (A-1), at least one of R^{1a} to R^{6a} is preferably a fluorine atom. Moreover, with respect to the sultone compounds of the formula (A-2), at least one of R^{1a} and R^{4a} to R^{6a} is preferably a fluorine atom.

With respect to the formulae (A), (A-1), and (A-2), the positions of a fluorine atom and a hydrocarbon group having a fluorine atom take place, are not particularly limited. However, it is preferable, for example, that at least one of R^{1a} to R^{4a}, particularly at least one of R^{1a} to R^{4a} is a fluorine atom and/or a hydrocarbon group having a fluorine atom (fluorine atom being preferred among the two).

With respect to the unsaturated sultone compounds of the formula (A-2), a fluorine atom preferably bonds, at least, to a carbon atom in the carbon-carbon double bond, that is, the one farther from the sulfur atom (i.e., R^{4a} is a fluorine atom). The unsaturated sultone compound having a fluorine atom at such a position is preferable in terms of easily forming on the negative electrode surface, without being adversely affected by steric hindrance caused by —SO₂—O—, a film which comprises a stable compound containing lithium and fluorine and which serves as an advantage to thermal stability of the battery.

The saturated sultone compounds represented by the foregoing formula (A-1) can specifically be represented by the following formulae (1) to (3).

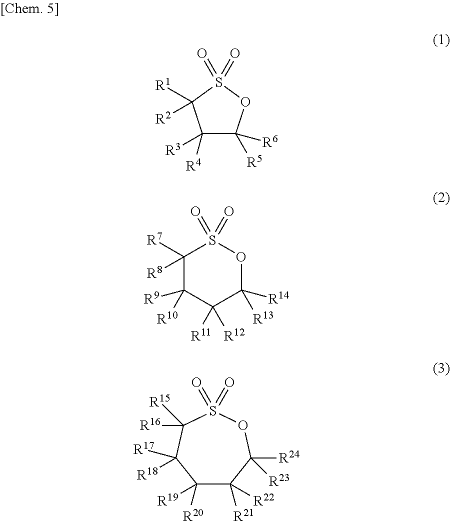

In the formulae (1) to (3), R¹ to R⁴, R⁷ to R¹⁰, and R¹⁵ to R¹⁸ correspond to the foregoing R^{1a} to R^{4a}; R⁵, R⁶, R¹¹, R¹², R¹⁹, and R²⁰ correspond to the foregoing R^{7a} and R^{8a}; R¹³, R¹⁴, R²¹, and R²² correspond to the foregoing R^{9a} and R^{10a}; and R²³ and R²⁴ correspond to the foregoing R^{11a} and R^{12a}.

Specific examples of the sultone compounds of the formulae (1) to (3), as, for example, saturated sultone compounds having a fluorine atom at the 2-position of the sultone ring, include 2-fluoro-1,3-propane sultone, 2-fluoro-1,4-butane sultone, and 2-fluoro-1,5-pentane sultone. 2-fluoro-1,4-butane sultone is a compound in which, in the formula (2), R⁷, R⁸, and R¹¹ to R¹⁴ are hydrogen atoms; and one of R⁹ and R¹⁰ is a fluorine atom while the other is a hydrogen atom. 2-fluoro-1,5-pentane sultone is a compound in which, in the formula (3), R¹⁵, R¹⁶, and R¹⁹ to R²⁴ are hydrogen atoms; and one of R¹⁷ and R¹⁸ is a fluorine atom while the other is a hydrogen atom.

The unsaturated sultone compounds represented by the formula (A-2) can be specifically represented by the following formulae (4) to (6).

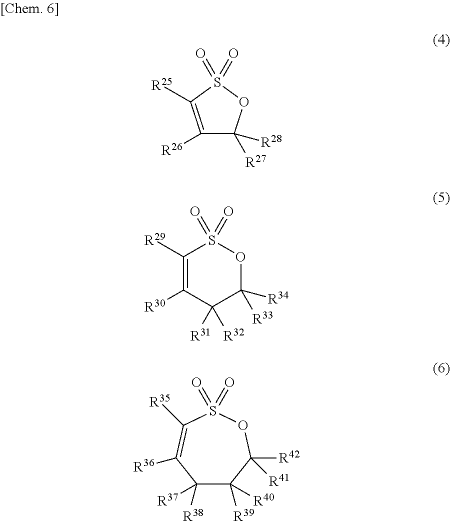

In the formulae (4) to (6), R²⁵, R²⁹, and R³⁵ correspond to the foregoing R^{1a}; R²⁶, R³⁰, and R³⁶ correspond to the foregoing R^{4a}; R²⁷, R²⁸, R³¹, R³²_{, R}³⁷, and R³⁸ correspond to the foregoing R^{7a} and R^{8a}; R³³, R³⁴, R³⁹, and R⁴⁰ correspond to the foregoing R^{9a} and R^{10a}; and R⁴¹ and R⁴² correspond to the foregoing R^{11a} and R^{12a}.

Specific examples of the sultone compounds of the formulae (4) to (6), as, for example, unsaturated sultone compounds having a fluorine atom at the 2-position of the sultone ring, include 2-fluoro-1,3-propene sultone, 2-fluoro-1,4-butene sultone, and 2-fluoro-1,5-pentene sultone. 2-fluoro-1,4-butene sultone is a compound in which, in the formula (5), R²⁹ and R³¹ to R³⁴ are hydrogen atoms; and R³⁰ is a fluorine atom. 2-fluoro-1,5-pentene sultone is a compound in which, in the formula (6), R³⁵ and R³⁷ to R⁴² are hydrogen atoms; and R³⁶ is a fluorine atom.

In terms of easier formation of a better film, the sultone compound is preferably at least one selected from the compounds represented by the formulae (1), (2), (4), and (5). Further preferable among the above, is the compound represented by the formula (1) and/or the compound represented by the formula (4).

Among the compounds represented by the formula (1), 2-fluoro-1,3-propane sultone represented by the formula (1a) below is particularly preferable; and among the compounds represented by the formula (4), 2-fluoro-1,3-propene sultone represented by the formula (4a) below is particularly preferable. Use of such compounds is advantageous in terms of being able to remarkably improve safety of a battery using a non-aqueous electrolyte with a large PC amount.

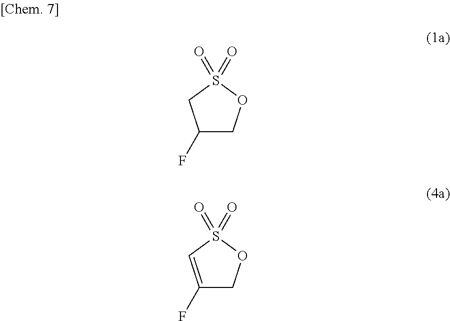 [SMILES: O=S1(=O)CC(F)CO1 ; O=S1(=O)C=C(F)CO1]

The content Wₛ of the sultone compound A in the non-aqueous electrolyte is, for example, 0.1 mass % or more, preferably 0.5 mass % or more, and further preferably 1 mass % or more; and is, for example, 5 mass % or less, preferably 4 mass % or less, and further preferably 3 mass % or less. The upper limit and the lower limit may be in arbitrary combinations. The content Wₛ being in such a range is advantageous in terms of being able to more effectively suppress gas generation caused by reductive decomposition of PC, and also, in terms of more effectively improving charge acceptance at the negative electrode as well as battery safety.

In terms of high-temperature storage characteristics, charge/discharge cycle characteristics, and safety of a non-aqueous electrolyte secondary battery, as well as of charge acceptance at the negative electrode, the content Wₛ of the sultone compound A in the non-aqueous electrolyte is, for example, 0.1 to 5 mass %, preferably 0.5 to 4 mass %, and further preferably 1 to 3 mass %.

The viscosity of the non-aqueous electrolyte is, for example, 2 to 10 mPa·s at 25° C. In terms of rate characteristics of a non-aqueous electrolyte secondary battery, the viscosity of the non-aqueous electrolyte at 25° C. is preferably 3 to 7 mPa·s. The viscosity can be measured, for example, with a cone-and-plate rotational viscometer.

In the present invention, a large amount of high-viscosity PC is used. However, by adding a low-viscosity solvent such as a chain carbonate to the non-aqueous electrolyte, the viscosity of the non-aqueous electrolyte can be easily controlled to that suited for use in a non-aqueous electrolyte secondary battery. In this case, in terms of adjusting the viscosity of the non-aqueous electrolyte to be in the foregoing range, the content of the chain carbonate in the non-aqueous solvent may be, for example, 10 to 50 mass %, preferably 20 to 50 mass %, and further preferably 30 to 50 mass %.

Among chain carbonates, DEC is particularly preferable in terms of more effectively improving rate characteristics of a non-aqueous electrolyte secondary battery in a low temperature environment. A content W_{DEC} of DEC in the non-aqueous solvent is, for example, 10 mass % or more, preferably 15 mass % or more, and further preferably 20 mass % or more. In terms of more effectively suppressing decomposition of DEC in a non-aqueous electrolyte secondary battery during storage in a high-temperature environment and during charge/discharge cycles, and more effectively suppressing gas generation caused by such decomposition of DEC, the content W_{DEC} of DEC is, for example, 50 mass % or less, preferably 45 mass % or less, and further preferably 40 mass % or less. The upper limit and the lower limit may be in arbitrary combinations. The content W_{DEC} of DEC is, for example, 10 to 50 mass %, preferably 15 to 45 mass %, and further preferably 20 to 40 mass %.

The ratio W_{DEC}/W_{EC} of the DEC content W_{DEC} of relative to the EC content W_{EC} is, for example, 1 to 5, preferably 1 to 4.5, and further preferably 1 to 4 or 2 to 4.5. The non-aqueous electrolyte having the ratio W_{DEC}/W_{EC} in the above range and the ratio W_{PC}/W_{EC} in the foregoing range, has a large PC content and relatively small EC and DEC contents. Therefore, it is possible to more effectively reduce the amount of gas generation derived from decomposition reactions of EC and DEC.

The non-aqueous solvent may contain other solvents in addition to EC, PC, and a chain carbonate. Examples of such other solvents include, but are not particularly limited to, cyclic carbonates other than EC and PC (e.g., butylene carbonate); cyclic carboxylic acid esters such as γ-butyrolactone; and fatty acid alkyl esters. These other solvents may be used singly or in a combination of two or more. The content of these other solvents may be, for example, 10 mass % or less and preferably 5 mass % or less, relative to the total of the non-aqueous solvent.

In addition to the sutone compound (A), the non-aqueous electrolyte may contain as necessary a known additive, examples thereof including: cyclic carbonates having a polymerizable unsaturated carbon-carbon bond, such as vinylene carbonate and vinyl ethylene carbonate; fluorine-containing compounds, such as cyclic carbonates having a fluorine atom such as fluoroethylene carbonate, fluorinated aromatic compounds, and fluorinated ethers; sultone compounds not having fluorine atoms, such as 1,3-propane sultone; cyclic sulfones such as sulfolane; sulfonate compounds such as methyl benzenesulfonate; and aromatic compounds such as cyclohexylbenzene, biphenyl, and diphenyl ether. These additives may be used singly or in a combination of two or more. The content of these additives is, for example, 10 mass % or less relative to the total of the non-aqueous electrolyte.

Examples of the solute in the non-aqueous electrolyte include, but are not particularly limited to, various lithium salts. Examples of the lithium salts include: lithium salts of inorganic acids (e.g., lithium salts of fluorine-containing acids, such as LiPF₆ and LiBF₄); and lithium imide compounds (e.g., lithium salts of fluorine-containing acid imides, such as LiN(CF₃SO₂)₂ and LiN(C₂F₅SO₂)₂). These lithium salts may be used singly or in a combination of two or more.

The concentration of the solute in the non-aqueous electrolyte is preferably 1.0 to 1.5 mol/L and further preferably 1.0 to 1.2 mol/L.

Such a non-aqueous electrolyte can prevent the non-aqueous solvent therein from reacting with the positive electrode and/or the negative electrode, and can therefore remarkably suppress gas generation which accompanies decomposition of the non-aqueous solvent. Therefore, the non-aqueous electrolyte of the present invention is suited for use as a non-aqueous electrolyte for batteries, particularly for non-aqueous electrolyte secondary batteries such as lithium ion secondary batteries.

(Non-aqueous Electrolyte Secondary Battery)

A non-aqueous electrolyte secondary battery of the present invention comprises a positive electrode, a negative electrode, a separator interposed between the positive and negative electrodes, and the foregoing non-aqueous electrolyte.

In the following, each of the components will be described in detail.

(Positive Electrode)

The positive electrode comprises: a positive electrode current collector; and a positive electrode mixture layer including a positive electrode active material and formed on the surface of the positive electrode current collector.

Examples of the material for the positive electrode current collector include stainless steel, aluminum, aluminum alloys, and titanium.

The positive electrode current collector may be a non-porous conductive substrate, or may be a porous conductive substrate having a plurality of through-holes. Examples of the non-porous current collector include a metal foil and a metal sheet. Examples of the porous current collector include a metal foil having continuous holes (perforations), a mesh, a punched sheet, and an expanded metal.

The thickness of the positive electrode current collector is, for example, 1 to 100 μm.

In addition to the positive electrode active material, the positive electrode mixture layer includes, for example, a conductive agent and a binder.

The positive electrode active material is preferably a lithium-containing transition metal composite oxide. Examples of exemplary lithium-containing transition metal composite oxides include LiCoO₂, LiNiO₂, LiMn₂O₄, and LiMnO₂.

In the present invention, the EC content is comparatively small. Therefore, even when the positive electrode active material is a lithium-containing transition metal composite oxide which further contains nickel being prone to cause decomposition of EC, gas generation can be suppressed considerably. A lithium-containing transition metal composite oxide further containing nickel is also advantageous due to its high capacity. In this composite oxide, the molar ratio of nickel relative to lithium is preferably 30 to 100 mol %.

It is preferable that the composite oxide further contains at least one selected from the group consisting of manganese and cobalt. In this case, in the composite oxide, the molar ratio of the total of manganese and cobalt, relative to lithium, is preferably 70 mol % or less.

A specific example of the lithium-nickel-containing composite oxide is a composite oxide represented by, for example, LiₓNi_{y}M_{z}Me_{1-(y+z)}O_{2+d}, where M is at least one element selected from the group consisting of Co and Mn; Me is at least one element selected from the group consisting of Al, Cr, Fe, Mg, and Zn; 0.98≦x≦1.1; 0.3≦y≦1; 0≦z≦0.7; 0.9≦y+z≦1; and −0.01≦d≦0.01. y is preferably 0.3≦y≦0.7 or 0.5≦y≦0.95.

Specific examples of the lithium-nickel-containing composite oxide include LiNi_{1/2}Mn_{1/2}O₂, LiNi_{1/2}Fe_{1/2}O₂, LiNi_{0.8}Co_{0.15}Al_{0.05}O₂, and LiNi_{1/3}Mn_{1/3}CO_{1/3}O₂.

The positive electrode active materials may be used singly or in a combination of two or more.

Examples of the conductive agent include carbon blacks such as acetylene black; conductive fibers such as carbon fibers; and carbon fluoride. The proportion of the conductive agent is, for example, 0.3 to 10 parts by mass per 100 parts by mass of the positive electrode active material.

Examples of the binder include fluorocarbon resins such as polyvinylidene fluoride (PVDF); acrylic resins such as polymethyl acrylate and ethylene-methyl methacrylate copolymer; and rubbery materials such as styrene-butadiene rubber, acrylic rubber, and modified products thereof.

The proportion of the binder is, for example, 0.3 to 10 parts by mass per 100 parts by mass of the positive electrode active material.

The positive electrode mixture layer can be formed, for example, by applying to the surface of the positive electrode current collector, a positive electrode mixture slurry containing the positive electrode active material, the conductive agent, the binder, and a dispersion medium; and then drying, and as necessary, rolling the resultant. The positive electrode mixture layer may be formed on one or both surfaces of the positive electrode current collector.

The thickness of the positive electrode mixture layer (thickness thereof per surface of the positive electrode current collector) is, for example, 20 to 120 μm.

Examples of the dispersion medium include water; alcohols such as ethanol; ethers such as tetrahydrofuran; N-methyl-2-pyrrolidone (NMP); and mixed solvents thereof.

The positive electrode mixture slurry may contain a thickener as necessary. Examples of the thickener include cellulose derivatives such as carboxymethyl cellulose (CMC); and poly C₂₋₄ alkylene glycols such as polyethylene glycol.

The proportion of the thickener is, for example, 0.1 to 10 parts by mass per 100 parts by mass of the positive electrode active material.

(Negative Electrode)

The negative electrode comprises a negative electrode current collector; and a negative electrode active material layer including a negative electrode active material and formed on the surface of the negative electrode current collector.

Examples of the material for the negative electrode current collector include stainless steel, nickel, copper, and copper alloys.

Examples of the form taken by the negative electrode current collector may be the same as those given for the positive electrode current collector. The thickness of the negative electrode current collector may also be selected from the same range as for the positive electrode current collector.

The negative electrode active material layer may be formed on one or both surfaces of the negative electrode current collector. The thickness of the negative electrode active material layer is, for example, 10 to 100 μm.

The negative electrode active material layer may be a film of the negative electrode active material that is deposited by vapor phase deposition; or may be a mixture layer including the negative electrode active material, a binder, and, as necessary, a conductive agent and/or a thickener.

The deposited film can be formed by allowing the negative electrode active material to be deposited on the surface of the negative electrode current collector by a method for vapor phase deposition, examples thereof including vacuum vapor deposition, sputtering, and ion plating. In this case, examples of the negative electrode active material include silicon, silicon compounds, and lithium alloys, all of which that will be described later.

The negative electrode mixture layer can be formed by preparing a negative electrode mixture slurry containing the negative electrode active material, the binder, a dispersion medium, and, as necessary, the conductive agent and/or the thickener; applying the slurry to the surface of the negative electrode current collector; and then drying, and as necessary, rolling the resultant.

Examples of the negative electrode active material include carbon materials; silicon and silicon compounds; and lithium alloys containing at least one selected from tin, aluminum, zinc, and magnesium.

Examples of the carbon materials include graphites, cokes, semi-graphitized carbons, graphitized carbon fibers, and amorphous carbons. Examples of the amorphous carbons include graphitizable carbon materials (soft carbons) that are easily graphitized by heat treatment at a high temperature (e.g., 2800° C.); and non-graphitizable carbon materials (hard carbons) that are almost not graphitized at all, even by heat treatment. Soft carbons have a structure as that of graphites, in which fine crystallites are arranged in nearly the same direction, whereas hard carbons have a turbostratic structure.

Examples of the silicon compounds include a silicon oxide represented by SiO_{α}, where 0.05≦α≦1.95. α is preferably 0.1 to 1.8 and further preferably 0.15 to 1.6. In the silicon oxide, a part of silicon may be replaced with one or more different elements, examples thereof including B, Mg, Ni, Co, Ca, Fe, Mn, Zn, C, N, and Sn.

The negative electrode active material is preferably the carbon material, and in terms of increasing the negative electrode capacity, is particularly preferably graphite particles. “Graphite particles” is a generic term for particles which include regions having a graphite structure. Thus, examples of the graphite particles include particles of natural graphite, of artificial graphite, and of mesophase pitch-based carbon subjected to graphitization. These kinds of graphite particles may be used singly or in a combination of two or more.

In terms of more effectively suppressing reductive decomposition of the non-aqueous solvent at the negative electrode, the negative electrode active material may, as necessary, be the graphite particles coated with a water-soluble polymer.

The diffraction pattern of the graphite particles measured by wide-angle X-ray diffractometry, shows peaks attributed to a (101) plane and a (100) plane, respectively. Herein, the ratio between a peak intensity I (101) attributed to a (101) plane, and a peak intensity I (100) attributed to a (100) plane, preferably satisfies 0.01<I (101)/I (100)<0.25, and further preferably satisfies 0.08<I (101)/I (100)<0.20. Note that peak intensity means peak height.

In terms of achieving high energy density, the mass of the graphite particles included in 1 cm³ of the negative electrode mixture layer is preferably 1.3 to 1.8 g and further preferably 1.5 to 1.8 g. Since the sultone compound A is highly competent in coating formation, a coating derived from the sultone compound A can be formed sufficiently on the graphite particle surface, even when the graphite particles of the above range are densely packed and the relative amount of the sultone compound A near the graphite particle surface is made small.

In terms of packing properties of the graphite particles, the average particle size (D50) of the graphite particles is, for example, 5 to 40 μm, preferably 10 to 30 μm, and further preferably 14 to 25 μm. The average particle size can be measured by, for example, a commercially-available laser diffraction particle size analyzer.

In terms of packing properties of the graphite particles, the average sphericity of the graphite particles is, for example, 0.85 to 0.95, and preferably 0.90 to 0.95. The average sphericity is expressed by 4 nS/L². Note that S is the area and L is the circumference, of the graphite particle when projected orthogonally. For example, the average sphericity of 100 arbitrary particles of the graphite particles is preferably in the above range.

When the graphite particles coated with the water-soluble polymer is used as the negative electrode active material, it is preferable that the graphite particles are already coated with the water-soluble polymer at the time of producing the negative electrode mixture layer. By coating the surface of the graphite particles with the water-soluble polymer, the non-aqueous electrolyte containing the sultone compound A can more easily permeate the negative electrode mixture layer, and can nearly uniformly form a coating thereof on the surface of the graphite particles.

Examples of the kinds of the water-soluble polymer include, but are not particularly limited to, cellulose derivatives; and poly C₂₋₄ alkylene glycols such as polyacrylic acid, polyvinyl alcohol, polyvinyl pyrrolidone, polyethylene glycol, and derivatives thereof (e.g., substitution products having substituents therein; partial esters). Among the above, cellulose derivatives and polyacrylic acid are particularly preferable.

Examples of the cellulose derivatives are preferably alkyl celluloses such as methyl cellulose; carboxyalkyl celluloses such as carboxymethyl cellulose (CMC); and alkali metal salts of carboxyalkyl celluloses, such as a Na salt of CMC. Examples of alkali metals for the alkali metal salts include potassium and sodium.

The weight average molecular weight of the cellulose derivative is, for example, preferably 10,000 to 1,000,000. The weight average molecular weight of the polyacrylic acid is preferably 5,000 to 1,000,000.

In terms of covering the particle surface to a moderate extent, the amount of the water-soluble polymer included in the negative electrode active material layer is, for example, 0.5 to 2.5 parts by mass and preferably 0.5 to 1.5 parts by mass, per 100 parts by mass of the graphite particles.

The coating of the water-soluble polymer on the graphite particles can be carried out by a known method. For example, the graphite particle surface may be coated by treating the graphite particles with the water-soluble polymer in advance of preparing the negative electrode mixture slurry.

The negative electrode is preferably produced in the following manner, so as to have the graphite particle surface coated with the water-soluble polymer. Herein, a first method and a second method will be described.

First, the first method will be described.

In the first method, the coating for the graphite particles can be carried out, by allowing an aqueous solution of the water-soluble polymer to adhere to the graphite particles and then drying the resultant. This method includes the step (step (a1)) of mixing the graphite particles, water, and the water-soluble polymer, and then drying the obtained mixture to obtain a dry mixture. For example, the water-soluble polymer is dissolved in water to prepare an aqueous solution of the water-soluble polymer. The obtained aqueous solution of the water-soluble polymer is mixed with the graphite particles, and thereafter, moisture is removed to dry the mixture. As such, by once drying the mixture, the water-soluble polymer efficiently adheres to the graphite particle surface, and the surface coverage of the water-soluble polymer on the graphite particles increases.

The viscosity of the aqueous solution of the water-soluble polymer is preferably controlled to 1 to 10 Pa·s at 25° C. The viscosity is measured with a Brookfield viscometer, using a 5 mmφ spindle that has a peripheral speed of 20 mm/s.

Moreover, the amount of the graphite particles mixed with 100 parts by mass of the aqueous solution of the water-soluble polymer, is preferably 50 to 150 parts by mass.

The drying temperature is preferably 80 to 150° C. The drying time is preferably 1 to 8 hours.

Next, the obtained dry mixture is mixed with a binder and a dispersion medium to prepare a negative electrode mixture slurry (step (a2)). By this step, a binder adheres to the graphite particle surface coated with the water-soluble polymer. Since slidability between the graphite particles are satisfactory, the binder, adhering to the graphite particle surface coated with the water-soluble polymer, is subjected to sufficient shearing force and effectively acts on the graphite particle surface coated with the water-soluble polymer.

Subsequently, the obtained negative electrode mixture slurry is applied to the negative electrode current collector and then dried to form a negative electrode mixture layer, thus resulting in obtaining a negative electrode (step (a3)). There is no particular limitation to the method for applying the negative electrode mixture slurry to the negative electrode current collector. For example, by using a die coater, the negative electrode mixture slurry is applied in a predetermined pattern to a base plate of the negative electrode current collector. There is also no particular limitation to the temperature for drying the applied slurry. After the applied slurry is dried, the resultant is rolled between rollers and controlled to a predetermined thickness. By the rolling step, bonding strength between the negative electrode mixture layer and the negative electrode current collector, as well as bonding strength among the graphite particles, increase. The negative electrode mixture layer obtained as above is cut together with the negative electrode current collector into a predetermined shape, thereby completing production of a negative electrode.

Next, the second method will be described.

The second method includes the step (step (b1) of mixing the graphite particles, a binder, water, and the water-soluble polymer, and then drying the obtained mixture to obtain a dry mixture. For example, the water-soluble polymer is dissolved in water to prepare an aqueous solution of the water-soluble polymer. The viscosity of the aqueous solution of the water-soluble polymer may be the same as that in the first method. Next, the obtained aqueous solution of the water-soluble polymer is mixed with the binder and the graphite particles, and thereafter, moisture is removed to dry the mixture. As such, by once drying the mixture, the water-soluble polymer and the binder efficiently adhere to the surface of the graphite particles. Thus, the surface coverage of the water-soluble polymer on the graphite particles is increased, and also, the binder satisfactorily adheres to the surface of the graphite particles coated with the water-soluble polymer. In terms of increasing the dispersibility of the binder in the aqueous solution of the water-soluble polymer, when the binder is mixed with the aqueous solution of the water-soluble polymer, it is preferably in the form of an emulsion, with water serving as a dispersion medium.

Next, the obtained dry mixture is mixed with a dispersion medium to prepare a negative electrode mixture slurry (step (b2). By this step, the graphite particles coated with the water-soluble polymer and the binder expand to a certain extent due to the dispersion medium, and properties that allow the graphite particles to slip and slide become satisfactory.

Then, the obtained negative electrode mixture slurry is applied to the negative electrode current collector in the same manner as in the first method, followed by drying and rolling to form a negative electrode mixture layer, thus resulting in obtaining a negative electrode (step (b3)).

In the first and second methods, there is no particular limitation to the dispersion medium that is used when preparing the negative electrode mixture slurry. However, water, an aqueous alcohol solution, or the like is preferable, and water is the most preferable. However, NMP or the like may also be used.

The content of the binder in the negative electrode mixture layer is, for example, 0.4 to 1.5 parts by mass and preferably 0.4 to 1 part by mass, per 100 parts by mass of the graphite particles. When the surface of the graphite particles is coated with the water-soluble polymer, slidability between the graphite particles improves, and therefore, the binder adhering to the graphite particle surface is subjected to sufficient shearing force and acts effectively on the graphite particle surface. Moreover, it is more likely for the binder, being in particle form and having a small average particle size, to come into contact with the graphite particle surface. Thus, the binder delivers the ability to bind sufficiently, even when it is used in small amounts.

The penetration rate of water into the negative electrode mixture layer is preferably 3 to 40 seconds, and can be controlled by, for example, the coating amount of the water-soluble polymer. By the penetration rate of water into the negative electrode mixture layer being 3 to 40 seconds, it is particularly easier for the non-aqueous electrolyte containing the sultone compound A to penetrate the negative electrode until reaching inside thereof. Thus, reductive decomposition of PC can be more satisfactorily suppressed. The penetration rate of water into the negative electrode mixture layer is further preferably 10 to 25 seconds.

The penetration rate of water into the negative electrode mixture layer is measured, for example, in an environment of 25° C. in the following manner.

Two μl of water is dropped to the surface of the negative electrode mixture layer, to allow a water droplet to come into contact therewith. By measuring the time it takes for the water contact angle θ on the negative electrode mixture layer surface to become smaller than 10°, the penetration rate of water into the negative electrode mixture layer can be obtained. The water contact angle on the negative electrode mixture layer surface may be measured with a commercially-available contact angle measuring device (e.g., DM-301 available from Kyowa Interface Science Co., Ltd.).

The binder, dispersion medium, conductive agent, and thickener for the negative electrode mixture slurry may be the same as those given as examples for the positive electrode mixture slurry.

The binder preferably is in particle form and has rubber elasticity. Such a binder is preferably a polymer having styrene units and butadiene units (e.g., styrene-butadiene rubber (SBR)). Such a polymer has excellent elasticity and is stable under a negative electrode potential.

The average particle size of the binder in particle form is, for example, 0.1 to 0.3 μm and preferably 0.1 to 0.25 μm. Note that the average particle size of the binder can be obtained by, for example, taking SEM images of 10 particles of the binder particles with use of a transmission electron microscope (available from JEOL Ltd., acceleration voltage: 200 kV) and then averaging out their maximum diameters.

The proportion of the binder is, for example, 0.4 to 1.5 parts by mass, and preferably 0.4 to 1 part by mass, relative to 100 parts by mass of the negative electrode active material. When the graphite particles coated with the water-soluble polymer is used as the negative electrode active material, properties that allow the negative electrode active material particles to slip and slide is high, and therefore, the binder adhering to the negative electrode active material particle surface is subjected to sufficient shearing force and acts effectively on the negative electrode active material particle surface. Moreover, it is more likely for the binder, being in particle form and having a small average particle size, to come into contact with the negative electrode active material particle surface. Thus, the binder delivers the ability to bind sufficiently, even when it is used in small amounts.

The proportion of the conductive agent is not particularly limited, and is, for example, 0 to 5 parts by mass relative to 100 parts by mass of the negative electrode active material. The proportion of the thickener is not particularly limited, and is, for example, 0 to 10 parts by mass relative to 100 parts by mass of the negative electrode active material.

The negative electrode can be produced in the same manner as the positive electrode. The thickness of the negative electrode active material layer is, for example, 30 to 110 μm.

The negative electrode active material layer may be formed on one or both surfaces of the negative electrode current collector. The thickness of the negative electrode active material layer (thickness thereof per surface of the negative electrode current collector) is, for example, 20 to 120 μm.

(Separator)

The separator can be a microporous film, non-woven fabric, woven fabric, or the like, made of resin. Examples of the resin for the separator include polyolefins such as polyethylene and polypropylene; polyamides; polyamide imides; polyimides; and celluloses.

The thickness of the separator is, for example, 5 to 100 μm, and preferably 10 to 30 μm.

(Others)

The non-aqueous electrolyte secondary battery is not particularly limited in shape, and may be cylindrical, flat, coin-shaped, prismatic, or the like.

The non-aqueous electrolyte secondary battery can be produced by a commonly-used method, in accordance with the shape, etc. of the battery. When the battery is cylindrical or prismatic, it can be produced by winding the positive electrode and the negative electrode with the separator interposed therebetween to produce an electrode assembly, and then housing the electrode assembly and injecting the non-aqueous electrolyte in a battery case.

The electrode assembly is not limited to a wound type, and may be a stacked type or a zigzag-folded type. The electrode assembly may be cylindrical or may be flat with its end surfaces perpendicular to the winding axis being oblong, in accordance with the shape of the battery or of the battery case.

Examples of the battery case material include aluminum, aluminum alloys (e.g., alloys which contain a very small amount of metal such as manganese or copper), and steel plates.

### EXAMPLES

In the following, the present invention will be described in detail with reference to Examples and Comparative Examples. However, it should be noted that the present invention is not limited to these Examples.

### Example 1

### (1) Production of Negative Electrode

Step (i)

CMC (molecular weight: 400 thousand) serving as a water-soluble polymer was dissolved in water to obtain an aqueous solution having a CMC concentration of 1.0 mass %. One hundred parts by mass of natural graphite particles (average particle size: 20 μm, average sphericity: 0.95) were mixed with 100 parts by mass of the aqueous CMC solution, and the mixture was stirred while controlling the temperature to stay at 25° C. Thereafter, the mixture was dried at 150° C. for 5 hours, to obtain a dry mixture. In the dry mixture, the CMC amount relative to 100 parts by mass of the graphite particles, was 1.0 part by mass.

Step (ii)

One hundred parts by mass of the dry mixture obtained in the step (i) was mixed with 0.6 part by mass of SBR in particle form (average particle size: 0.12 μm) serving as a binder; 0.9 part by mass of CMC; and a appropriate amount of water, to prepare a negative electrode mixture slurry. Note that when the SBR was mixed with the other components, it was in the form of an emulsion with water serving as a dispersion medium (BM-400B (trade name) available from Nippon Zeon Co., Ltd., SBR content: 40 mass %).

Step (iii)

The obtained negative electrode mixture slurry was applied with a die coater to both surfaces of an electrolytic copper foil (thickness: 12 μm) serving as a negative electrode current collector, to form films. The films were dried at 120° C., and then the dry films were rolled between rollers under a linear pressure of 250 kg/cm, to form negative electrode mixture layers (thickness: 160 μm, graphite density: 1.65 g/cm³). The negative electrode mixture layers were cut together with the negative electrode current collector into a predetermined shape to obtain a negative electrode.

(2) Production of Positive Electrode

Four parts by mass of PVDF serving as a binder and 8 parts by mass of acetylene black serving as a conductive agent were added to 100 parts by mass of LiNi_{0.80}Co_{0.15}Al_{0.05}O₂ serving as a positive electrode active material, and then the resultant was mixed together with a appropriate amount of NMP to prepare a positive electrode mixture slurry. The obtained positive electrode mixture slurry was applied with a die coater to both surfaces of a 20 μm-thick aluminum foil serving as a positive electrode current collector to form films. The films were dried at 120° C., and then the dry films were rolled between rollers under a linear pressure of 1800 kg/cm to form positive electrode mixture layers (thickness: 140 μm). The positive electrode mixture layers were cut together with the positive electrode current collector into a predetermined shape to obtain a positive electrode.

(3) Preparation of Non-Aqueous Electrolyte

A sultone compound was added to a mixed solvent of EC, PC, and DEC, and then LiPF₆ was dissolved in the resultant to prepare a non-aqueous electrolyte. The sultone compound used was a compound represented by the formula (1a) (hereinafter, compound (1a)). EC, PC, DEC, and the compound (1a) in the non-aqueous electrolyte were in proportions by mass of 10:50:40:1. The LiPF₆ concentration in the non-aqueous electrolyte was 1 mol/liter.

The viscosity of the non-aqueous electrolyte at 25° C. was measured with a rotational viscometer (radius of cone plate: 24 mm). The viscosity of the non-aqueous electrolyte at 25° C. was 5.4 mPa·s.

(4) Assembling of Battery

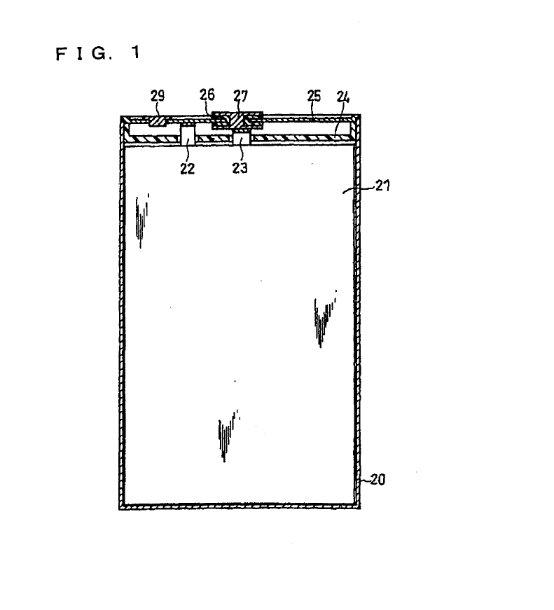

A prismatic lithium ion secondary battery as illustrated in FIG. 1 was produced.

The negative electrode and the positive electrode were wound with a 20 μm-thick microporous polyethylene film (A089 (trade name) available from Celgard, LLC) serving as a separator, to produce an electrode assembly 21 having a substantially elliptic cross section. The electrode assembly 21 was housed in a prismatic aluminum battery can 20. The battery can 20 had a bottom, side walls, an opening at the top, and a substantially rectangular shape. The thickness of the main flat portion of the side walls was 80 μm.

Thereafter, an insulating body 24 was disposed on top of the electrode assembly 21, for it to prevent short circuits between the battery can 20 and a positive lead 22 or negative lead 23. Next, a rectangular sealing plate 25, having at its center a negative terminal 27 surrounded by an insulating gasket 26, was arranged at the opening of the battery can 20. The negative lead 23 was connected to the negative terminal 27. The positive lead 22 was connected to the lower surface of the sealing plate 25. The edge outlining the opening of the battery can 20, and the sealing plate 25, were welded together with laser to seal the opening of the battery can 20. Thereafter, 2.5 g of the non-aqueous electrolyte was injected into the battery can 20, from an injection hole of the sealing plate 25. Finally, the injection hole was closed with a sealing stopper 29 by welding to complete production of a prismatic lithium ion secondary battery (battery 1) having a height of 50 mm, a width of 34 mm, a width of inside space of about 5.2 mm, and a design capacity of 850 mAh.

### Example 2

A battery 2 was produced in the same manner as Example 1, except for using as the sultone compound, a compound represented by the formula (4a) (hereinafter, compound (4a)) in place of the compound (1a).

### Comparative Example 1

A battery 3 was produced in the same manner as Example 1, except for using as the sultone compound, 1,3-propane sultone in place of the compound (1a).

### Comparative Example 2

A battery 4 was produced in the same manner as Example 1, except for using as the sultone compound, 1,3-propene sultone in place of the compound (4a).

Each of the batteries of Examples 1 to 2 and Comparative Examples 1 to 2 was evaluated as follows.

[Evaluations]

(1) Evaluation of Capacity Retention Rate During Charge/Discharge Cycles

The battery was subjected to repeated charge/discharge cycles at 45° C. In the charge/discharge cycle, for charge, the battery was charged at a constant current of 600 mA until the voltage reached 4.2 V, and then charged at a constant voltage of 4.2 V. The charge time, that is, the total time required for the constant-current charge and constant-voltage charge, was 2 hours and 30 minutes. Also, the rest time after the charge was 10 minutes. On the other hand, for discharge, the battery was discharged at a constant current of 850 mA until the voltage reached 2.5 V. The rest time after the discharge was 10 minutes.

Discharge capacities at the 3^{rd} and 500^{th} cycles were obtained, respectively. Referring to the discharge capacity at the 3^{rd} cycle as 100%, the discharge capacity at the 500^{th} cycle was calculated as capacity retention rate X (%) during charge/discharge cycles.

(2) Evaluation of Battery Swelling (Gas Generation) During Charge/Discharge Cycles

The battery was subjected to repeated charge/discharge cycles under the same conditions as (1) above. Thickness measurements were taken on the battery after the charge at the 3^{rd} cycle and after the charge at the 501^{st} cycle, respectively, at the center of a 50 mm (height)×34 mm (width) plane of the battery, in a direction perpendicular to the plane. The amount of battery swelling (mm) was obtained from the thickness difference between the battery after the charge at the 3^{rd} cycle and that after the charge at the 501^{st} cycle.

(3) Evaluation of Capacity Retention Rate During High-Temperature Storage

For each of the Examples and the Comparative Examples, two batteries of the same specification were prepared.

One battery of the two was charged and discharged at 25° C. For charge, the one battery was charged at a constant current of 600 mA until the voltage reached 4.2 V, and then charged at a constant voltage of 4.2 V. The charge time, that is, the total time required for the constant-current charge and constant-voltage charge, was 2 hours and 30 minutes. Also, the rest time after charge was 10 minutes. On the other hand, for discharge, the one battery was discharged at a constant current of 170 mA until the voltage reached 2.5 V. Discharge capacity during this discharge was obtained, and was regarded as discharge capacity before storage.

The other battery of the two was charged under the same conditions as the above, and then stored at 85° C. for 3 days. The other battery after the storage was left in a 25° C. environment for 6 hours, and was then discharged under the same conditions as the above. Thereafter, the other battery was again charged and discharged under the same conditions as above. Discharge capacity during this discharge was obtained, and was regarded as discharge capacity after storage.

Referring to the discharge capacity before storage as 100%, the discharge capacity after storage was calculated as capacity retention rate Y (%) after high-temperature storage.

(4) Evaluation of Battery Swelling (Gas Generation) During High-Temperature Storage

Thickness measurements were taken on the one battery of (3) above before the storage and the other battery of (3) above after the storage, respectively, at the center of a 50 mm (height)×34 mm (width) plane of each of the batteries, in a direction perpendicular to the plane. The amount of battery swelling (mm) after high-temperature storage was obtained from the thickness difference between the one battery before the storage and the other battery after the storage.

(5) Evaluation of Battery Safety

The battery was charged and discharged under the same conditions as (1) above, for 3 cycles in a 25° C. environment. Next, for the 4^{th} cycle, the battery was charged at a constant current of 600 mA in a −5° C. environment until the voltage reached 4.25 V, and then charged at a constant voltage of 4.25 V. The charge time for the 4^{th} cycle was 2 hours and 30 minutes. Thereafter, the battery was heated at 5° C./min until reaching 130° C., and then kept at 130° C. for 3 hours. The temperatures of the battery surface at this time were measured with use of a thermocouple, and its maximum temperature was obtained.

The evaluation results are shown in Table 1.

TABLE 1

| | | | Charge/ | | | | |
|---|---|---|---|---|---|---|---|
| | | | Discharge | | High-temperature | | |
| | | | Cycle | | Storage | | Safety |
| | | | Characteristics | | Characteristics | | Maximum |
| | | | Capacity | | Capacity | | Temperature |
| | | Kind of | Retention | Battery | Retention | Battery | of Battery |
| | Battery | Sultone | Rate X | Swelling | Rate Y | Swelling | Surface |
| | No. | Compound | (%) | (mm) | (%) | (mm) | (° C.) |
| Ex. 1 | 1 | Formula | 87.0 | 0.23 | 87.6 | 0.18 | 135 |
| | | (1a) | | | | | |
| Ex. 2 | 2 | Formula | 87.5 | 0.22 | 88.0 | 0.16 | 134 |
| | | (4a) | | | | | |
| Comp. | 3 | 1,3- | 82.1 | 0.46 | 85.1 | 0.25 | 167 |
| Ex. 1 | | propane | | | | | |
| | | sultone | | | | | |
| Comp. | 4 | 1,3- | 86.6 | 0.34 | 84.3 | 0.29 | 168 |
| Ex. 1 | | propene | | | | | |
| | | sultone | | | | | |

Compared to batteries 3 and 4 of Comparative Examples 1 and 2, batteries 1 and 2 of Examples 1 and 2 exhibited better charge/discharge cycle characteristics, high-temperature storage characteristics, and safety.

The reason for the batteries of the Examples being less swollen is presumably because of decreased gas generation due to suppression of reductive decompositions of PC and DEC at the negative electrode. Particularly, in the Examples, reductive decomposition of PC at the negative electrode was effectively suppressed, presumably because the sultone compound used in the Examples had a higher reductive potential than the sultone compound used in the Comparative Examples, therefore allowing a film thereof to be formed on the negative electrode surface, at a higher potential than the reductive potential of PC.

Moreover, in the Comparative Examples, maximum temperatures of the battery surface temperature were high. This is because heat was generated considerably in the batteries stored at 130° C., with lithium deposited on their negative electrode surfaces due to having been overcharged in a low-temperature environment. In contrast, in the Examples, the maximum temperatures of the battery surface temperature were substantially no different from the stored temperatures. This is presumably because heat generation was suppressed in the batteries of the Examples, due to the deposited lithium being made stable by the sultone compound containing a fluorine atom.

### Example 2

The content Wₛ of the sultone compound in the non-aqueous electrolyte was changed to values as shown in Table 2. EC, PC, and DEC serving as the non-aqueous solvent were in proportions by mass of 1:5:4.

Other than the above, batteries 11 to 19 were each produced and then evaluated, in the same manner as Example 1. Note that battery 11 is a comparative example.

The evaluation results are shown in Table 2. Note that in Table 2, the discharge capacity (index) for each battery at the 3^{rd} cycle during the charge/discharge cycle test is expressed as an index with reference to the discharge capacity of Battery 15 at the 3^{rd} cycle as 100.

TABLE 2

| | | Charge/ | | High- | | Discharge | |
|---|---|---|---|---|---|---|---|
| | | Discharge Cycle | | temperature Storage | | Capacity | Safety |
| | Content | Characteristics | | Characteristics | | at 3^{rd} | Maximum |
| | W_{S} of | Capacity | | Capacity | | Cycle of | Temperature |
| | Sultone | Retention | Battery | Retention | Battery | Charge/ | of Battery |
| Battery | Compound A | Rate X | Swelling | Rate Y | Swelling | Discharge | Surface |
| No. | (mass %) | (%) | (mm) | (%) | (mm) | (index) | (° C.) |
| 11 | 0 | charge/discharge not possible | | | | | |
| (comp. | | | | | | | |
| ex.) | | | | | | | |
| 12 | 0.05 | 81.2 | 0.47 | 87.0 | 0.21 | 93 | 139 |
| 13 | 0.1 | 85.5 | 0.34 | 87.1 | 0.20 | 99 | 136 |
| 14 | 0.5 | 86.2 | 0.28 | 87.2 | 0.19 | 100 | 136 |
| 15 | 1 | 87.0 | 0.23 | 87.6 | 0.18 | 100 | 135 |
| 16 | 3 | 87.1 | 0.23 | 87.5 | 0.18 | 100 | 132 |
| 17 | 4 | 86.3 | 0.29 | 87.2 | 0.19 | 100 | 131 |
| 18 | 5 | 85.0 | 0.35 | 87.0 | 0.20 | 99 | 131 |
| 19 | 7 | 80.9 | 0.48 | 87.0 | 0.22 | 94 | 137 |

Battery 11, in which the non-aqueous electrolyte did not contain the sultone compound A, was unable to be charged or discharged because the film was not formed sufficiently, and thus, reductive decomposition of PC could not be suppressed sufficiently.

In contrast, compared to battery 11, batteries 12 to 19 exhibited more improvement in charge/discharge cycle characteristics, high-temperature storage characteristics, and safety.

This is presumably because the non-aqueous electrolyte contained the sultone compound containing a fluorine atom, thereby allowing these batteries to obtain, in accordance with the content of the sultone compound therein, the same effect as in battery 1. Among these batteries, batteries 13 to 18 exhibited still more improvement in charge/discharge cycle characteristics, high-temperature storage characteristics, and safety. All of these batteries were contrasted with one another in regard to the discharge capacity at the 3^{rd} cycle, and batteries 13 to 18 were found to exhibit high discharge capacities. Therefore, in the non-aqueous electrolyte, the content of the sultone compound containing a fluorine atom is preferably in the range of 0.1 to 5 mass %.

### Example 3

The content W_{PC} of PC in the non-aqueous solvent was changed to values as shown in Table 3, and EC and DEC were in proportions by mass of 10:30. The sultone compound A was used such that its content was 1, relative to the total mass of EC, PC, and DEC referred to as 100.

Other than the above, each of batteries 21 to 29 were produced and then evaluated, in the same manner as Example 1. Note that batteries 21, 22, and 29 are comparative examples.

The evaluation results are shown in Table 3.

TABLE 3

| | | Charge/ | | | | |
|---|---|---|---|---|---|---|
| | | Discharge | | High-temperature | | |
| | | Cycle | | Storage | | Safety |
| | | Characteristics | | Characteristics | | Maximum |
| | | Capacity | | Capacity | | Temperature |
| | | Retention | Battery | Retention | Battery | of Battery |
| Battery | Content W_{PC} of | Rate X | Swelling | Rate Y | Swelling | Surface |
| No. | PC (mass %) | (%) | (mm) | (%) | (mm) | (° C.) |
| 21 | 0 | 60.5 | 0.80 | 75.4 | 1.02 | 135 |
| (comp. | | | | | | |
| ex.) | | | | | | |
| 22 | 35 | 76.6 | 0.55 | 77.5 | 0.61 | 134 |
| (comp. | | | | | | |
| ex.) | | | | | | |
| 23 | 40 | 81.3 | 0.46 | 82.0 | 0.36 | 134 |
| 24 | 42 | 82.2 | 0.38 | 83.8 | 0.29 | 135 |
| 25 | 45 | 85.8 | 0.25 | 87.3 | 0.19 | 135 |
| 26 | 55 | 86.0 | 0.26 | 87.6 | 0.18 | 135 |
| 27 | 58 | 82.1 | 0.39 | 87.7 | 0.17 | 134 |
| 28 | 60 | 80.6 | 0.48 | 87.7 | 0.17 | 134 |
| 29 | 75 | 71.4 | 0.50 | 76.4 | 0.60 | 135 |
| (comp. | | | | | | |
| ex.) | | | | | | |

Batteries 23 to 28 exhibited excellent charge/discharge cycle characteristics, high-temperature storage characteristics, and safety.

In battery 29, the PC amount became excessively large, thus increasing the amount of gas generated due to reductive decomposition of PC, and reducing the capacity retention rates X and Y. In batteries 21 and 22, the PC amount became excessively small, thus increasing the amount of gas generated due to oxidative decompositions of EC and DEC, and reducing the capacity retention rates X and Y.

### Example 4

The content W_{EC} of EC in the non-aqueous solvent was changed to values as shown in Table 4, and PC and DEC were in proportions by mass of 50:40. The sultone compound A was used such that its content was 1, relative to the total mass of EC, PC, and DEC referred to as 100.

Other than the above, each of batteries 31 to 39 were produced and then evaluated, in the same manner as Example 1. Note that batteries 31, 32, and 39 are comparative examples.

The evaluation results are shown in Table 4.

TABLE 4

| | | Charge/ | | High- | | |
|---|---|---|---|---|---|---|
| | | Discharge | | temperature | | Safety |
| | | Cycle | | Storage | | Maximum |
| | Content | Characteristics | | Characteristics | | Temper- |
| | W_{EC} of | Capacity | Battery | Capacity | Battery | ature |
| | EC | Retention | Swell- | Retention | Swell- | of Battery |
| Battery | (mass | Rate X | ing | Rate Y | ing | Surface |
| No. | %) | (%) | (mm) | (%) | (mm) | (° C.) |
| 31 | 0 | charge/discharge not possible | | | | |
| (comp. | | | | | | |
| ex.) | | | | | | |
| 32 | 1 | charge/discharge not possible | | | | |
| (comp. | | | | | | |
| ex.) | | | | | | |
| 33 | 5 | 80.3 | 0.46 | 85.1 | 0.30 | 138 |
| 34 | 7 | 85.7 | 0.27 | 86.7 | 0.24 | 137 |
| 35 | 10 | 87.0 | 0.23 | 87.6 | 0.18 | 135 |
| 36 | 15 | 86.6 | 0.25 | 87.0 | 0.19 | 133 |
| 37 | 18 | 82.8 | 0.39 | 84.2 | 0.28 | 132 |
| 38 | 20 | 81.1 | 0.47 | 82.5 | 0.36 | 131 |
| 39 | 25 | 77.0 | 0.51 | 78.3 | 0.59 | 131 |
| (comp. | | | | | | |
| ex.) | | | | | | |

Batteries 33 to 38 exhibited excellent charge/discharge cycle characteristics, high-temperature storage characteristics, and safety.

Batteries 31 and 32 were unable to be charged or discharged due to the EC amount being excessively small. In battery 39, the EC amount became excessively large, thus increasing the amount of gas generated due to oxidative decomposition, and reducing the capacity retention rates X and Y.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### INDUSTRIAL APPLICABILITY

According to the present invention, gas generation can be suppressed in a non-aqueous electrolyte secondary battery during storage in a high-temperature environment and/or during repeated charge/discharge. Therefore, the non-aqueous electrolyte of the present invention is useful for secondary batteries used in electronic devices such as cellular phones, personal computers, digital still cameras, game consoles, and portable audio equipment.

### EXPLANATION OF REFERENCE NUMERALS

20 battery can
21 electrode assembly
22 positive lead
23 negative lead
24 insulating body
25 sealing plate
26 insulating gasket
27 negative terminal
29 sealing stopper

1. A non-aqueous electrolyte comprising a non-aqueous solvent, a solute dissolved in the non-aqueous solvent, and an additive,
the non-aqueous solvent including ethylene carbonate and propylene carbonate,
a content W_{EC} of the ethylene carbonate in the non-aqueous solvent being 5 to 20 mass %,
a content W_{PC} of the propylene carbonate in the non-aqueous solvent being 40 to 60 mass %, and
the additive comprising a sultone compound which includes a fluorine atom.

2. The non-aqueous electrolyte in accordance with claim 1, wherein the sultone compound is a compound represented by the following formula (A): 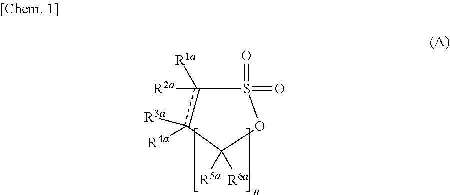
where R^{1a} to R^{6a} are independently a fluorine atom, a hydrogen atom, or a hydrocarbon group that may have a fluorine atom; R^{2a} and R^{3a} may be taken together to form a double bond; n is a number of repetitions for a methylene group having R^{5a} and R^{6a}, and is an integer of 1 to 3; when n is 2 or 3, R^{5a} and R^{6a} in the methylene groups may be the same respectively or be different from each other; and at least one of R^{1a} to R^{6a} is a fluorine atom, or a hydrocarbon group having at least one fluorine atom.

3. The non-aqueous electrolyte in accordance with claim 1, wherein the sultone compound is at least one selected from the group consisting of:
a compound represented by the following formula (1): 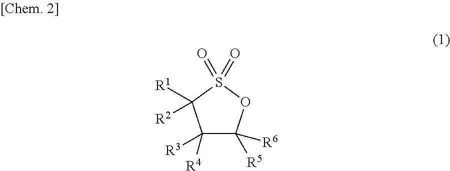
where R¹ to R⁶ are independently a fluorine atom, a hydrogen atom, or a hydrocarbon group that may have a fluorine atom; and at least one of R¹ to R⁶ is a fluorine atom or a hydrocarbon group having at least one fluorine atom;
a compound represented by the following formula (2): 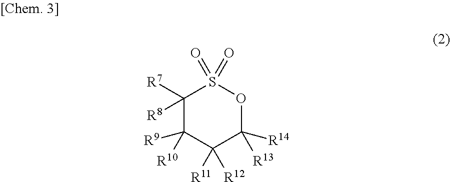
where R⁷ to R¹⁴ are independently a fluorine atom, a hydrogen atom, or a hydrocarbon group that may have a fluorine atom; and at least one of R⁷ to R¹⁴ is a fluorine atom or a hydrocarbon group having at least one fluorine atom; and
a compound represented by the following formula (3): 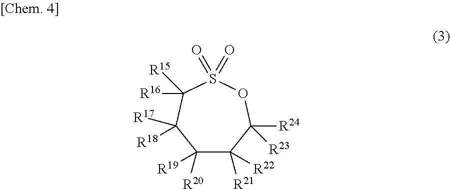
where R¹⁵ to R²⁴ are independently a fluorine atom, a hydrogen atom, or a hydrocarbon group that may have a fluorine atom; and at least one of R¹⁵ to R²⁴ is a fluorine atom or a hydrocarbon group having at least one fluorine atom.

4. The non-aqueous electrolyte in accordance with claim 1, wherein the sultone compound is represented by the following formula (1a):

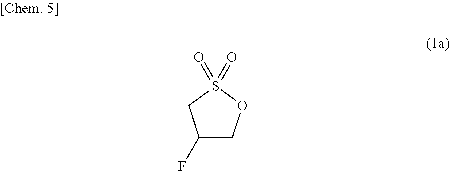

5. The non-aqueous electrolyte in accordance with claim 1, wherein the sultone compound is at least one selected from the group consisting of:
a compound represented by the following formula (4): 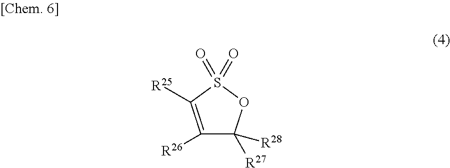
where R²⁵ to R²⁸ are independently a fluorine atom, a hydrogen atom, or a hydrocarbon group that may have a fluorine atom; and at least one of R²⁵ to R²⁸ is a fluorine atom or a hydrocarbon group having at least one fluorine atom;
a compound represented by the following formula (5): 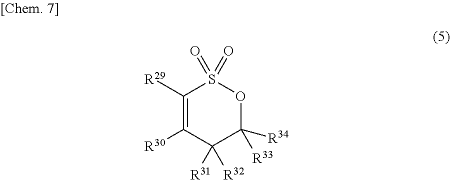
where R²⁹ to R³⁴ are independently a fluorine atom, a hydrogen atom, or a hydrocarbon group that may have a fluorine atom; and at least one of R²⁹ to R³⁴ is a fluorine atom or a hydrocarbon group having at least one fluorine atom; and
a compound represented by the following formula (6): 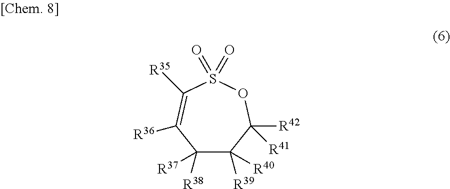
where R³⁵ to R⁴² are independently a fluorine atom, a hydrogen atom, or a hydrocarbon group that may have a fluorine atom; and at least one of R³⁵ to R⁴² is a fluorine atom or a hydrocarbon group having at least one fluorine atom.

6. The non-aqueous electrolyte in accordance with claim 1, wherein the sultone compound is a compound represented by the following formula (4a):

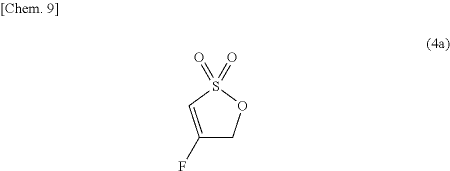

7. The non-aqueous electrolyte in accordance with claim 1, wherein a content Wₛ of the sultone compound in the non-aqueous electrolyte is 0.1 to 5 mass %.

8. A non-aqueous electrolyte secondary battery comprising:
a positive electrode including a positive electrode current collector, and a positive electrode mixture layer formed on a surface of the positive electrode current collector and including a positive electrode active material;
a negative electrode including a negative electrode current collector, and a negative electrode active material layer formed on a surface of the negative electrode current collector and including a negative electrode active material;
a separator interposed between the positive electrode and the negative electrode; and
the non-aqueous electrolyte in accordance with claim 1.

9. The non-aqueous electrolyte secondary battery in accordance with claim 8, wherein the negative electrode active material includes graphite particles.

10. The non-aqueous electrolyte secondary battery in accordance with claim 9, wherein a weight of the graphite particles included in 1 cm³ of the negative electrode active material layer is 1.3 to 1.8 g.

11. The non-aqueous electrolyte secondary battery in accordance with claim 9, wherein the graphite particles are coated with at least one selected from the group consisting of a cellulose derivative and polyacrylic acid.

12. The non-aqueous electrolyte secondary battery in accordance with claim 8, wherein a film derived from the sultone compound is formed on a surface of the negative electrode active material layer.

13. The non-aqueous electrolyte secondary battery in accordance with claim 8, wherein the positive electrode active material includes a lithium-nickel-containing composite oxide represented by LiₓNi_{y}M_{z}Me_{1-(y+z)}O_{2+d}, where M is at least one element selected from the group consisting of Co and Mn; Me is at least one element selected from the group consisting of Al, Cr, Fe, Mg, and Zn;
0.98≦x≦1.1; 0.3≦y≦1; 0≦z≦0.7; 0.9≦y+z≦1; and
−0.01≦d≦0.01.
